(19) United States
(12) Patent Application Publication
(10) Pub. No.: US 2022/0237808 A1
(43) Pub. Date: Jul. 28, 2022

(54) MOTION ANALYSIS SYSTEM AND MOTION TRACKING SYSTEM COMPRISING SAME OF MOVED OR MOVING OBJECTS THAT ARE THERMALLY DISTINCT FROM THEIR SURROUNDINGS

(71) Applicant: SIMI REALITY MOTION SYSTEMS GMBH, UNTERSCHLEISSHEIM (DE)

(72) Inventors: ANDREAS RUSS, UNTERSCHELEISSHEIM (DE); PHILIPP RUSS, UNTERSCHLEISSHEIM (DE)

(21) Appl. No.: 16/607,744

(22) PCT Filed: Apr. 24, 2017
(86) PCT No.: PCT/DE2017/100331

§ 371 Date: Oct. 24, 2019

(30) Foreign Application Priority Data
Apr. 25, 2016 (DE) 10 2016 107 667.8

(51) Int. Cl. G06T 7/292; H04N 5/247; G06T 7/11; G06T 7/246

(52) U.S. Cl. CPC G06T 7/292; H04N 5/247; G06T 7/11; G06T 2207/30196; G06T 2207/10016; G06T 2207/10048; G06T 7/251

(57) ABSTRACT

A motion analysis system and motion tracking system for capturing moved or moving objects that are thermally distinct from their surroundings. The system has a camera group with at least one thermographic camera, a calibration unit, a synchronization unit, a segmentation unit, a reconstruction unit, a projection unit and an identification unit. Such a system advantageously allows a thermally aided segmentation both of the 2D thermogragraphic images and of any 2D video images, specifically irrespective of the ambient conditions of an object to be analyzed and/or to be tracked and without requiring marker elements attached to the object.

### FIELD OF THE INVENTION

The present invention relates to a motion analysis system and to a motion tracking system comprising same of moved or moving objects that are thermally distinct from their surroundings.

### BACKGROUND OF THE INVENTION

The demand for motion analysis and/or tracking systems of moved or moving objects is widespread and exists in a great variety of fields. Primarily, motion analyses are performed on living objects such as people to improve biomechanics in medicine or sport and to uncover weak points in a motion sequence. A comparable objective is pursued in industrial objects with the analysis of the movement sequences of robot arms or such grippers. The basis of any motion analysis is here the reliable capturing in particular of distance and angle/orientation data, if possible in real time.

### Marker-Based Systems

In many applications, the object to be analyzed is provided here with a plurality of marker elements. Data capturing is effected using video cameras that record the changes in position of the marker elements provided on the locomotor system of the object by way of continuous digital storing of 2D video images using at least one video image recorder and feed said recordings to a data processing system for evaluation.

A difficulty with these applications is to track the movement of each individual marker element in the 2D video image in real time and to automatically assign a unique identity thereto.

A system that is adapted in this way has become known commercially under the name Aktisys® and is thoroughly described in WO 2011/141531 A1.

### Markerless Systems

In addition to marker-based systems, there is also a high demand in the field of motion analysis and tracking for flexibly usable systems that operate without the provision of additional markers on the target object.

To achieve this, motion analysis and/or tracking systems that aim to localize markerless objects in digital image sequences have been developed. In this respect, reference is made by way of example to U.S. Pat. No. 7,257,237 B1, WO 2008/109567 A2, and WO 2012/156141 A1. Although additionally a multiplicity of various publications on this topic exists, known markerless motion analysis and/or tracking systems differ very little in terms of their basic principle. All known systems require a form of segmentation of the video images which produces 2D pixel regions according to predefined homogeneity criteria and assigns them to the objects to be captured.

The known prior markerless motion analysis and/or tracking systems which have been used, however, function adequately only under laboratory conditions with stable and controlled properties of the environment and/or of the target objects.

Outside a controlled laboratory environment, automatic, robust and highly precise motion analysis and/or tracking is not available, however, in the current prior art. Stable segmentation in any desired surroundings is here in particular prevented by
moving objects in the background of the video images, such as spectators at a sports event or trees moving in the wind, etc.; and/or
quickly and non-homogeneously changing illumination intensities such as moved light sources (headlights), moved shadow sources (clouds) or reflections of moved surfaces (water), etc.; and/or
insufficient illumination intensities as are found in particular in caves, chambers or in the case of twilight/night recordings, etc.

All these items present huge challenges in particular for applications in the outdoor area.

### Possible Uses of Interest

However, without solving the described problems relating to segmentation, outdoor applications remain closed for the use of motion analysis and/or tracking systems. This applies for example to the analysis of sports competitions in the open air and the behavior analysis of animals in their natural surroundings. But applications of interest in enclosed spaces (sports competition analysis, safety technology, animal research) must also overcome some of the described obstacles when the environment of an object to be analyzed and/or tracked cannot be adapted in a dedicated fashion, as in a lab, to the use of the known systems.

### The Object on Which the Invention is Based

Proceeding herefrom, the present invention is based on the object of providing an improved motion analysis system and a motion tracking system comprising same of moved or moving objects that are thermally distinct from their surroundings,
which overcomes the above prior art problems when used outside a controlled laboratory environment,
preferably without the need to provide marker elements on the object.

### Solution According to the Invention

The object on which the present invention is based is achieved by a motion analysis system and a motion tracking system comprising same of moved on moving objects that are thermally distinct from their surroundings, having the features of independent patent claims 1 and 12.

Advantageous configurations of the invention, which are able to be used alone or in combination with one another, are stated in the dependent claims.

A motion analysis system according to the invention is characterized by a camera group having at least one thermal imaging camera, a calibration unit, a synchronization unit, a segmentation unit, a reconstruction unit, a projection unit, and also an identification unit.

A motion tracking system according to the invention comprises such a motion analysis system and is characterized by a motion tracking unit performing a reorientation of a model of the object(s) from assigned correspondences.

Both systems advantageously make thermally supported segmentation independently of the environment conditions of an object that is to be analyzed and/or tracked and without the need for marker elements to be applied on the object possible.

### New Possible Uses

The present invention opens up possible uses for motion analysis and/or tracking systems that are of interest here which have hitherto been closed, in particular in the fields of sports competition analysis, safety technology, and animal research:

Sport science currently has, among other things, the problem that movements are analyzed especially in laboratories but not where the sports movements actually take place: under competition conditions and outside. By way of markerless capturing and thermally supported segmentation as taught with the present invention, it is now possible for the first time to analyze the exact biomechanics for example of a soccer player at the moment his cruciate ligament injury happens and to track his movements. This and similar information is highly relevant for the sport, in particular in view of explaining and illustrating performance and injury issues.

Moreover, the data recorded by the thermal imaging camera(s) can also advantageously be used for thermographic analysis. Thermographic measurement methods offer the possibility to directly ascertain the average skin temperature during a sports activity and also to image the muscle groups that are involved in a movement. Thereby, physiological sequences of thermoregulation of the body cannot only be tracked directly, but rather it is also possible to intensively study sport-type-specific issues during physical activity. In general medicine, thermographic analysis is primarily used to detect local foci of inflammation. Since the generation and emission of heat in a healthy body are relatively symmetric, deviations from this symmetry can imply injuries and possibly illnesses. For example, diseased blood vessels, the formation of specific cancerous cells, thyroid dysfunctions, but also bone fractures or, in the case of a comparatively lower heat emission, circulatory problems can thus be detected in thermographic images.

More recent scientific work shows that people can also be identified on the basis of their unique gait and motion pattern. Where methods such as fingerprints and facial recognition reach their limits, motion features may be more difficult to bypass. Using a system of markerless motion analysis and/or tracking and thermally supported segmentation as taught with the present invention, it is also possible for the first time to use gait and motion patterns as features when identifying persons.

In the field of research of animal habitat or animal behavior patterns (zoology) and in preclinical research, the analysis and/or tracking of the motion of animals is an essential research element. Here, new medical methods are investigated particularly in the areas of Parkinson's disease, paresis and Alzheimer's. Placing markers on animals is difficult because they generally do not accept markers. Markerless capturing is here particularly in demand. However, very small end effectors and obscuration by fur frequently make clean segmentation and motion analysis and/or tracking more difficult. Furthermore, specially installed light sources influence the behavior of animals and thus falsify the data obtained. Using thermally supported segmentation as taught with the present invention, it is possible finally for the first time to bypass these problems and to offer effective markerless motion analysis and/or tracking in animals.

### BRIEF DESCRIPTION OF THE DRAWINGS

Additional details and further advantages of the invention will be described below with reference to preferred exemplary embodiments, to which the present invention is, however, not limited, and in connection with the attached drawings.

Schematically:

FIG. 1 shows an example of a motion analysis and/or tracking system according to the invention on the basis of a flowchart;

FIG. 2 shows an example of the arrangement of a first group of cameras comprising at least one thermal imaging camera and at least two video image cameras;

FIG. 3 shows an example of the arrangement of a second group of cameras, comprising at least two thermal imaging cameras and possibly video image cameras;

FIG. 4 shows an example of the arrangement of a third group of cameras, exclusively comprising two or more thermal imaging cameras; and

FIG. 5 shows an example of the arrangement of a fourth group of cameras, comprising a multiplicity of thermal imaging and video image cameras having an arbitrary arrangement in relation to one another.

### DETAILED DESCRIPTION OF THE FIGURES In the below description of preferred embodiments of the present invention, identical reference signs designate identical or comparable components.

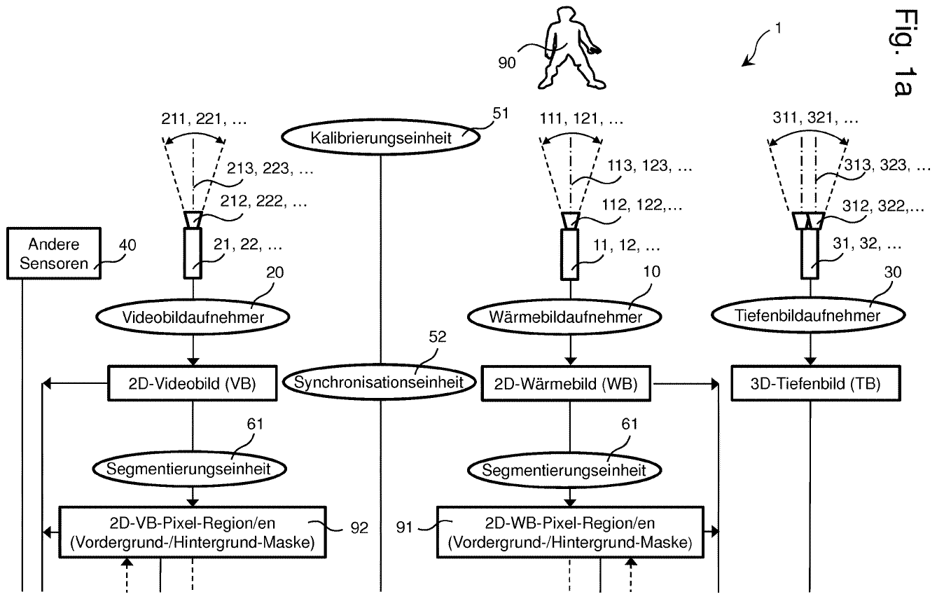

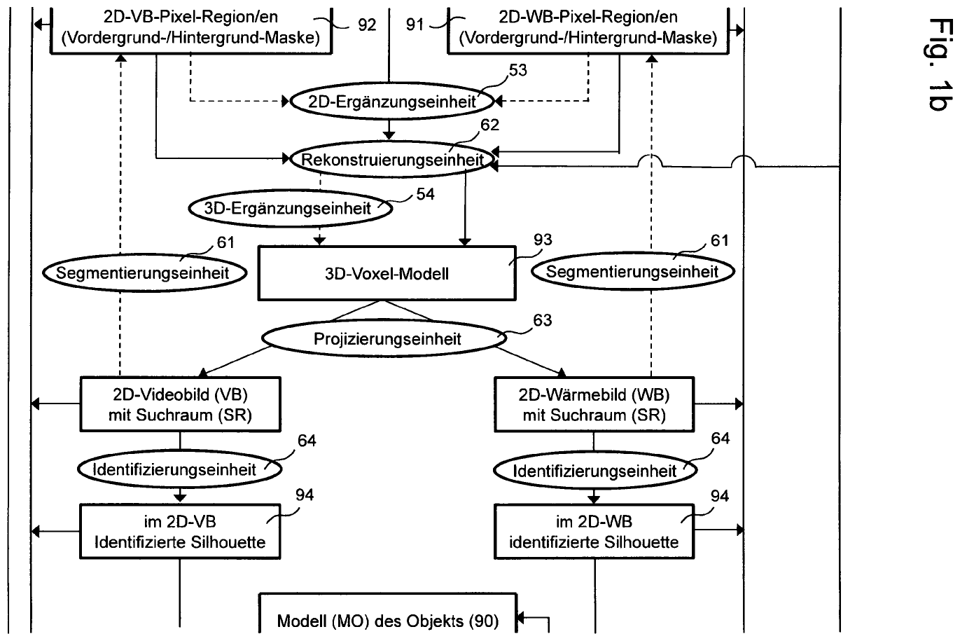

FIG. 1 shows (distributed over three sheets: FIGS. 1a, 1b, 1c) an example of a motion analysis and/or tracking system 1 according to the invention on the basis of a flowchart.

Here, in the context of the present invention, “video image cameras” 21, 22, . . . designate devices that record electromagnetic radiation in the visible light range (wavelength range from 400 to 780 nm) using specific detectors (video image recorder 20) and generate 2D (two-dimensional) video images VB from the electrical signals obtained. Said 2D video images VB are present then in the form of pixel graphics.

A pixel graphic is a computer-readable form of the description of an image in which the picture elements (pixels) are arranged in the form of a grid, and a pixel value is assigned to each pixel. In the case of 2D video images VB in the context of this invention, the pixel value that is assigned to the pixels is typically a specific color (a specific wavelength of visible light).

The term “voxel” (volumetric pixel) is correspondingly understood to mean a data element (“picture” element) in a three-dimensional grid.

In the context of the invention, 3D voxel models 93 of the object(s) 90 are reconstructed, that is to say designed, from segmented 2D pixel regions 91; 92 of recordings of at least two cameras by way of a reconstruction unit 62 according to the invention. The design (reconstruction) of a 3D voxel model 93 from segmented 2D pixel regions is occasionally also referred to as “space carving.”

“Thermal imaging cameras” 11, 12, . . . in the context of the present invention designate devices that record electromagnetic radiation in the infrared range (“thermal radiation”; wavelength range: 780 nm to 1 mm), which is emitted in particular by living objects (people, animals). The pixel values of the 2D thermal images WB thus obtained represent temperature values which can also be advantageously used for a plausibility check of depth information in the 2D thermal image WB and/or 2D video image VB.

In this respect, the invention utilizes the fact that the body temperature of living objects (people, animals) is normally distinct from the temperature of inanimate objects 90 in the environment, meaning the silhouettes of living objects can be extracted well from the inanimate environment (as a background) from thermal images using what are known as threshold value methods (“thresholding”). Environment influences such as illumination conditions, color similarity between object and background, and any shadows as are disturbing for video cameras are irrelevant in thermal imaging cameras.

Even in the case of strong solar irradiation and the associated warming of the environment in comparison to the body temperature of living objects, it is nevertheless advantageously possible to distinguish silhouettes from the background, in particular by way of calibrating the temperature range of the image recording to a narrow region around the respective body temperature.

The motion analysis system according to the invention is initially characterized by a group of cameras 11, 12, . . . ; 21, 22, . . . having any desired arrangement in relation to one another such
that the field of view 111, 121, . . . ; 211, 221, . . . of each camera 11, 12, . . . ; 21, 22, . . . overlaps with the field of view 111, 121, . . . ; 211, 221, . . . of at least one other camera 11, 12, . . . ; 21, 22, . . . of the group such that all fields of view 111, 121; 211, 211, . . . are at least indirectly connected, and
that the camera group comprises at least a first and a second camera, the objective lenses 112, 122, . . . ; 212, 222, . . . of which are arranged at a distance x of at least two meters from one another and/or the optical axes 113, 123, . . . ; 213, 223, . . . of which are oriented at an angle a of at least 45° with respect to one another,
   wherein the first camera is a thermal imaging camera 11 for recording thermal radiation via continuous digital storage of 2D thermal images WB using at least one thermal imaging recorder 10, and
   wherein the second camera
      is a further thermal imaging camera 12
   or
      is a video image camera 21 for recording light radiation via continuous digital storage of 2D video images VB using at least one video image recorder 20.

Using a calibration unit 51, simultaneous spatial 3D calibration of all thermal cameras 11, 12, . . . and possibly video cameras 21, 22, . . . with overlapping fields of view 111, 121, . . . ; 211, 221, . . . is ensured, for example according to the known prior art.

In addition, a synchronization unit 52 ensures that the recording, that is to say the continuous digital storage, of 2D thermal images WB and any 2D video images VB is effected at the same time and/or the recording time points of the 2D thermal images WB and any 2D video images VB are known. In the case of a mixed camera group comprising thermal cameras 11, 12, . . . and video image cameras 21, 22, . . . , it has proven expedient to preferably set the frequency of the video cameras 21, 22, . . . to an integer multiple of the frequency of the thermal camera 11, 12, . . . . The recording time points can be controlled for example by an external trigger signal.

The invention furthermore provides a segmentation unit 61 which segments, that is to say determines, associated 2D pixel regions 91; 92 of the object(s) 90 in the 2D thermal images WB and any 2D video images VB according to predefined homogeneity criteria. The term “segmentation” here refers to the creation of regions that are connected in terms of content by grouping together adjacent pixels or voxels according to predefined homogeneity criteria. According to the invention, preferably in particular image processing methods 80 such as background subtraction, edge detection, thresholding, region-based methods and the orientation on model silhouettes (calculated from MO) can be used for the segmentation. Here, it is possible to optionally apply different methods to 2D thermal images WB than to 2D video images VB, for example Bayes classifiers. “Homogeneity criteria” in the context of the invention are in particular the pixel and/or voxel values “color” and/or “temperature.”

Using a reconstruction unit 62 according to the invention, it is then possible to reconstruct, that is to say design, a 3D voxel model 93 of the object(s) 90 from segmented 2D pixel regions 91; 92. The design (reconstruction) of a 3D voxel model 93 from segmented 2D pixel regions is occasionally also referred to as “space carving.” In the context of the present invention, the selection of the cameras 11, 12, . . . ; 21, 22, . . . that are in fact used for “space carving” can advantageously be effected in a manner specific to the application, that is to say flexibly—for example, all thermal cameras 11, 12, . . . ; 21, 22, . . . may always be used or only the thermal cameras 11, 12, . . . may be used. Taking account of the fields of view 111, 121, . . . ; 211, 221, . . . of a plurality of spatially offset cameras 11, 12, . . . ; 21, 22, . . . , the objective lenses 112, 122, . . . ; 212, 222, . . . of which are arranged at a distance x of at least two meters from one another and/or the optical axes 113, 123, . . . ; 213, 223, . . . of which are oriented at an angle a of at least 45° with respect to one another, advantageously permits the reconstruction of a 3D voxel model 93, in which each 3D voxel combines the information of a plurality of pixels recorded in different fields of view 111, 121, . . . ; 211, 221, . . . from synchronously available 2D thermal images WB and/or any 2D video images VB. Synchronization 52 and calibration 51 are necessary requirements for the reconstruction unit 62.

The present invention is furthermore characterized by a projection unit 63, by means of which the 3D voxel model 93, which combines the pixels from a plurality of synchronously available 2D thermal images WB and/or any 2D video images VB, as reference for a search space SR, is projected back into the 2D thermal images WB and any 2D video images VB. Here, the back-projected pixels of the 3D voxel model 93 correspond to the fields of view 111, 121, . . . ; 211, 221, . . . of the respective 2D thermal images WB and/or any 2D video images VB, wherein segmentations of individual 2D thermal images WB and/or any 2D video images VB that can be difficult to segment in particular profit from good segmentation results of synchronously available 2D thermal images WB and/or any 2D video images VB from the fields of view 111, 121, . . . ; 211, 221, . . . of other cameras 11, 12, . . . ; 21, 22, . . . .

This has the advantage that the identification of silhouettes 94 of the obj ect(s) 90 in the individual 2D thermal images WB and/or any 2D video images VB can be limited to the search space SR thus produced. Consequently, the present invention, finally, is characterized by an identification unit 64, by means of which silhouettes 94 of the object(s) 90 can be identified, i.e. detected, in synchronously available 2D thermal images WB and any 2D video images VB on the basis of the search space SR that is defined by the back projection.

The motion analysis system according to the invention advantageously makes possible thermally supported segmentation, both of the 2D thermal images and also of any 2D video images, specifically independently of the environment conditions of an object 90 that is to be analyzed and/or tracked and without the need for marker elements to be provided on the object 90. The present invention thus opens up previously closed possible uses for motion analysis and/or tracking systems 1 that are of interest here, in particular in the fields of sports competition analysis, safety technology, and animal research.

If the image frequency, that is to say the number of images per unit time, of the 2D video images VB recorded using a video image camera 21, 22, . . . is greater than the image frequency of the 2D thermal images WB recorded using a thermal imaging camera 11, 12, . . . , a preferred configuration of the invention proposes a 2D supplementation unit 53 that supplements missing 2D thermal images WB in a manner such that a synchronous 2D thermal image WB is always present for each 2D video image VB. To this end, a keyframe interpolation device (not illustrated) has proven expedient, for example, for the data of the 2D thermal image WB in practice.

If the model frequency, that is to say the number of produced models per unit time, of the 3D voxel models 93 produced by the reconstruction unit 62 is lower than the image frequency of the 2D thermal images WB recorded using a thermal imaging camera 11, 12, . . . and/or any 2D video images VB recorded using a video camera 21, 22, . . . , a preferred configuration of the invention proposes a 3D supplementation unit 54 that supplements missing 3D voxel models 93 in a manner such that for each 2D thermal image WB and any 2D video image VB a synchronous 3D voxel model 93 is always present. Here, too, a keyframe interpolation device (not illustrated) has proven expedient, for example, for the 3D data of the voxel model 93 in practice.

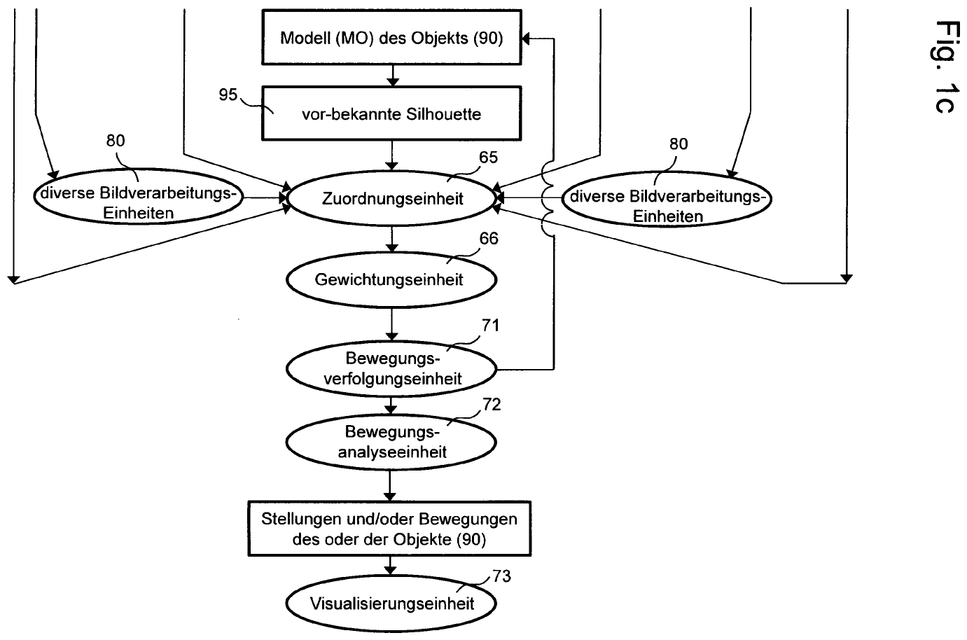

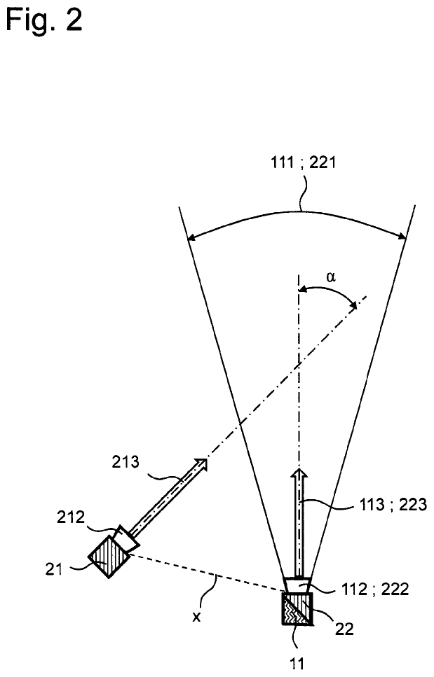

FIG. 2 shows an example of the arrangement of a first group of cameras, comprising at least one thermal imaging camera 11, 12, . . . and at least two video image cameras 21, 22, . . . . FIG. 2 shows how
a thermal imaging camera 11 as a first camera and a video image camera 21 as a second camera are provided, the objective lenses 112; 212 of which are arranged at a distance x of at least two meters from one another and/or the optical axes 113; 213 of which are oriented at an angle a of at least 45° with respect to one another,
and how a video image camera 22 is provided as a third camera, the objective lens 222 of which is arranged immediately adjacent to the objective lens 112 of the thermal imaging camera 11 such that the optical axes 113; 223 of both cameras 11, 22 are substantially oriented parallel with respect to one another.

The arrangement of at least one thermal imaging camera 11 in a group of cameras comprising at least two video cameras 21, 22, . . . advantageously permits at least a first plausibility check of only insufficiently segmentable 2D video images VB by the segmentation unit 61 and thus the advantageous reconstruction of 3D voxel models 93 containing fewer errors than can be found in the prior art.

FIG. 1 optionally shows an iterative sequence (process), in which the segmentation unit 61 and the reconstruction unit 62 are cycled through repeatedly. Here, the motion analysis and/or tracking system 1 in a further preferred configuration comprises a further segmentation unit 61, which additionally takes into consideration limitations of the search space SR based on the results of the 3D voxel model of the preceding iteration step and adapts homogeneity criteria to the current iteration step. This advantageously increases the robustness of the system 1; in particular segmentations of individually poorly segmentable 2D thermal images WB and/or any 2D video images VB profit from good segmentation results in other synchronously available 2D thermal images WB and/or any 2D video images VB from the fields of view 111, 121, . . . ; 211, 221, . . . of other cameras 11, 12, . . . ; 21, 22, . . . .

In an alternative or cumulative configuration, the robustness of the system 1 can be increased further by a reconstruction unit 62, which selects, in an iterative sequence, additionally the segmented 2D pixel regions 91, 92 used for reconstruction of the 3D voxel model 93 in dependence on the current iteration step, the type of the camera 11; 21; 31 and/or the quality criteria of the 2D pixel regions. In particular, a reconstruction unit 62 which reconstructs the 3D voxel model 93 additionally on the basis of the depth image TB of a depth image camera 31 has proven expedient. As a result, an iterative sequence of search space limitations is advantageously available, consisting of segmentation unit 61, reconstruction unit 62, and projection unit 63.

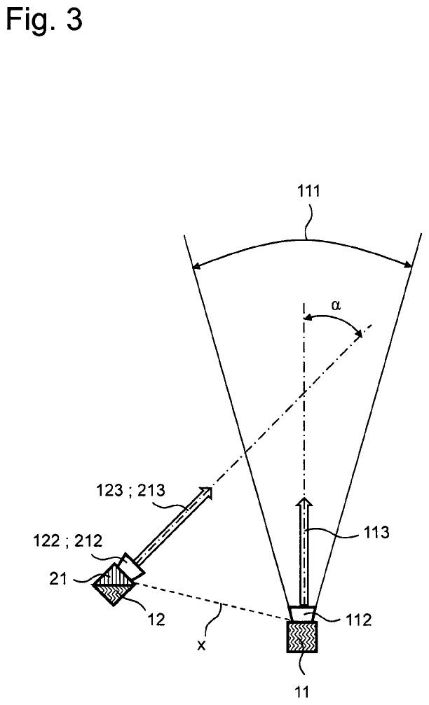

FIG. 3 shows an example of the arrangement of a second group of cameras, comprising at least two thermal imaging cameras 11, 12, . . . and possibly video image cameras 21, 22, . . . . FIG. 3 shows how, for example,
a thermal imaging camera 11 is provided as a first camera and a thermal imaging camera 12 is provided as a second camera, the objective lenses 112; 122 of which are arranged at a distance x of at least two meters from one another and/or the optical axes 113; 123 of which are oriented at an angle a of at least 45° with respect to one another,
and how a video image camera 21 is provided as a third camera, the objective lens 212 of which is arranged directly adjacent to the objective lens 122 of the second thermal imaging camera 12 in a manner such that the optical axes 123; 213 of both cameras 12, 21 are oriented substantially parallel with respect to one another.

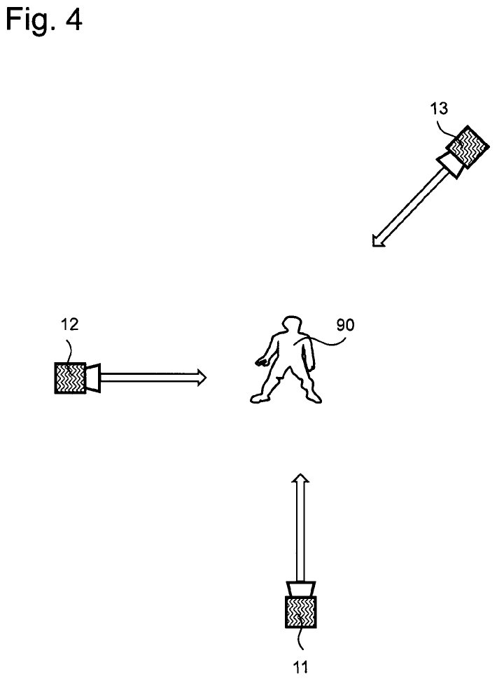

FIG. 4 shows an example of the arrangement of a third group of cameras, comprising a multiplicity of, in particular two to three, thermal imaging cameras 11, 12, . . . and, in particular five to six, video imaging cameras 21, 22, . . . of any desired arrangement in relation to one another. In the case of fewer cameras, the positions of the cameras would expediently be occupied in the order of the camera numbers 11, 12, . . . ; 21, 22, . . . or be adapted to the specific requirements of the application-specific motion analysis and/or tracking.

The arrangement of a group of cameras comprising at least two thermal imaging cameras 11, 12, . . . —as proposed for example in FIG. 3 or FIG. 4—advantageously permits a particularly reliable segmentation of 2D thermal images WB using the segmentation unit 61. For example, as few as two thermal cameras 11, 12, . . . , the optical axes 113, 123, . . . of which are arranged at an appropriate angle a, allow the reconstruction of a 3D voxel model 93 purely from 2D thermal images WB. For this reason, a reconstruction unit 62 which initially reconstructs a 3D voxel model 93 of the object(s) 90 only from segmented 2D WB pixel regions 91 is preferred according to the invention.

The 3D WB voxel model 93 obtained in this way purely from data of the 2D thermal image WB is particularly reliable in as far as it offers a particularly robust limitation of a search space SR in the 2D video images VB of the video cameras 21, 22, . . . . For this reason, a projection unit 63 which initially projects back a 3D thermal image WB voxel model 93 as a reference for a search space SR into the synchronously available 2D thermal images WB and any 2D video images VB is preferred according to the invention.

In a further preferred configuration, the motion analysis and/or tracking system 1 furthermore comprises an assignment unit 65 which assigns points of the identified silhouettes 94 points of previously known silhouettes 95 of a model MO of the object(s) 90 as a correspondence and/or assigns points of the previously known silhouettes 95 of a model MO of the object(s) 90 points of the identified silhouettes 94 as correspondence. The model MO advantageously represents a virtual imaged presentation of the object(s) 90. In a typical case, it will be embodied as a kinematic chain with an associated dot grid and possibly further references on sensors. It is thus possible to project the model MO in its current orientation into the 2D thermal images WB and any 2D video images VB using the calibration unit 51 and to determine the outline, i.e. the silhouette 95.

An assignment unit 65 which, optionally, additionally to the correspondences obtained from data of the silhouettes 95, uses data in particular of further sensors 40, any image processing units 80 and/or a depth image camera 31, 32, . . . for establishing correspondences has in particular proven expedient here. These are correlated with status variables of a model MO, that is to say properties with respect to the current orientation of a model MO. As a result, an assignment unit which advantageously establishes additional correspondences by assigning further status variables of a model MO of the obj ect(s) 90 to data in particular of further sensors 40, any image processing units 80 and/or a depth image camera 31, 32, . . . is obtainable. In particular, orientation sensors (gyroscopes), acceleration sensors or active thermal markers have proven expedient. In terms of image processing units 80, known facial recognition means, pattern recognition means or what are known as pattern matches are preferred. The depth image camera 31, 32, . . . used can be any camera that permits imaging representation of distances. In this case, every pixel does not receive the color of the object 90 that can be seen, as in a video camera 21, 22, . . . , or the temperature of the object, as in a thermal imaging camera 11, 12, . . . , but the distance of the point of the object 90 that is visible in the corresponding pixel. Depth image cameras 31, 32, . . . are available in different embodiments, such as:
stereo cameras;
structured light; here, a light pattern, produced from light of the visible or infrared wavelength range, is projected onto the scene to be recorded, is recorded with a camera, and the depth information is calculated from the distortion of the pattern with respect to the non-distorted pattern;
time-of-flight (TOF) cameras, which infer the distance from time-of-flight measurements of the light; or
light field cameras, which determine not only the position and intensity of the incident light, but also the angle, and thus permit calculation of depth information.

A weighting unit 66 which weights established correspondences in accordance with fixedly predefined and/or variable parameters has also proven expedient. In particular, weighting criteria that a user can adapt possibly using parameters can be implemented.

In a further preferred embodiment, the motion analysis and/or tracking system 1 furthermore comprises a motion tracking unit 71, which performs a reorientation of a model MO of the object(s) 90 from assigned correspondences.

Here, in particular a motion tracking unit 71 which, in an iterative procedure, carries out after each iteration, with already present correspondences and/or with correspondences which have been re-established on the basis of an updated model MO, a reorientation of a model MO of the object(s) 90 until the orientation of the model MO meets a predefined criterion has proven expedient. Such a criterion is met for example when the orientation of the model MO changes less than a predefined threshold value or when a specific number of iterations has been reached. This advantageously provides new silhouettes 95.

In a further preferred embodiment, the motion analysis and/or tracking system 1 furthermore comprises a motion analysis unit 72, which analyzes poses, in particular knee or other joint angles that are present, and/or movements of the obj ect(s) 90 from a finally available orientation of a model MO of the object(s) 90.

In a further advantageous embodiment, the motion analysis and/or tracking system 1 can be supplemented by a visualization unit 73. Here, a visualization unit 73 with which it is possible optionally to present the temperature data of the segmented 2D WB pixel regions 91 on the 3D voxel model 93 or on an, in particular finally, aligned model MO using texture mapping has proven expedient. Such visualization of the temperature data can advantageously make possible thermographic analyses in particular during the motion sequence of an object 90 to be examined.

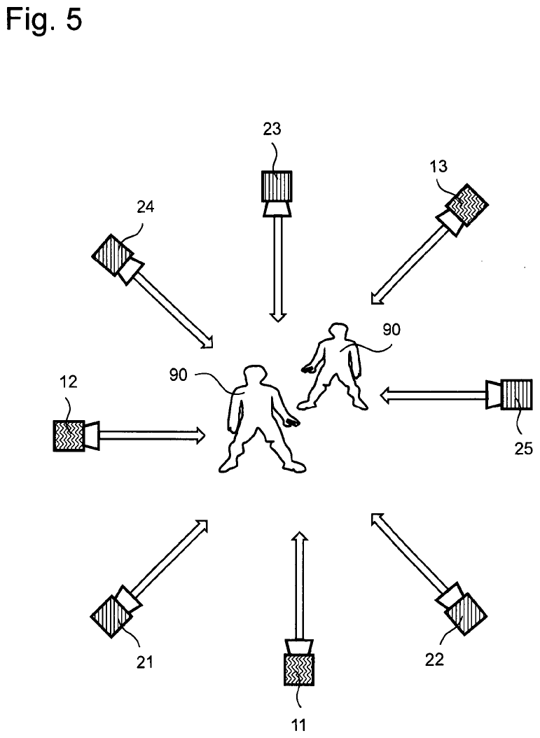

Finally, FIG. 5 shows an example of the arrangement of a fourth group of cameras, exclusively comprising two or more thermal imaging cameras 11, 12, 13, . . . . FIG. 5 shows how the objective lenses 112, 122, 132 of the three thermal imaging cameras 11, 12, 13, which are illustrated by way of example, are arranged at a distance x of at least two meters from one another and/or whose optical axes 113, 123, 133 are orientated at an angle α of at least 45° with respect to one another. The arrangement of a group of cameras formed exclusively from thermal imaging cameras 11, 12, 13, . . . advantageously permits the motion analysis and/or tracking of objects 90 even in complete darkness, which is of interest in particular for researching nocturnal animals or in crime control.

The motion analysis and/or tracking system 1 according to the invention advantageously permits thermally supported segmentation, both of the 2D thermal images and of any 2D video images, specifically independently of the environment conditions of an object 90 that is to be analyzed and/or tracked and without the need for marker elements to be provided on the object 90. The present invention thus opens up previously closed possible uses for motion analysis and/or tracking systems 1 that are of interest here, in particular in the fields of sports competition analysis, safety technology, and animal research.

### LIST OF REFERENCE SIGNS

1 motion analysis and/or tracking system
10 thermal imaging recorder
11, 12, . . . thermal imaging cameras
111, 121, . . . field of view of the thermal imaging camera (11, 12, . . . )
112, 122, . . . objective lens of the thermal imaging camera (11, 12, . . . )
113, 123, . . . optical axis (direction of view) of the thermal imaging camera (11, 12, . . . )
20 video image recorder
21, 22, . . . video image cameras
211, 221, . . . field of view of the video image camera (21, 22, . . . )
212, 222, . . . objective lens of the video image camera (21, 22, . . . )
213, 223, . . . optical axis (direction of view) of the video image camera (21, 22, . . . )
30 depth image recorder
31, 32, . . . depth image cameras
311, 321, . . . field of view of the depth image camera (31, 32, . . . )
312, 322, . . . objective lens of the depth image camera (31, 32, . . . )
313, 333, . . . optical axis (direction of view) of the depth image camera (31, 32, . . . )
40 other sensors
51 calibration unit
52 synchronization unit
53 2D supplementation unit, in particular keyframe interpolation device
54 3D supplementation unit, in particular keyframe interpolation device
61 segmentation unit
62 reconstruction unit
63 projection unit
64 identification unit
65 assignment unit
66 weighting unit
71 motion tracking unit
72 motion analysis unit
73 visualization unit
80 various image processing units
90 object
91 2D WB pixel regions(s) of the object(s) (90)
92 2D VB pixel regions(s) of the object(s) (90)
93 3D voxel model of the object(s) (90)
94 identified silhouettes of the object(s) (90)
95 (previously) known silhouettes of the model (MO) of the object(s) (90)
MO model of the object (90)
WB 2D thermal image
VB 2D video image
TB depth image
SR search space
x distance between the objective lens (112) of the first camera (11) and the objective lens (122) or (212) of the second camera (12) or (21)
α angle between the optical axis (113) of the first camera (11) and the optical axis (123) or (213) of the second camera (12) or (21)

1.-15. (canceled)

16. A motion analysis system for at least one moved or moving object which is thermally distinct from their surroundings, the motion analysis system comprising:
a group of cameras having an arrangement in relation to one another such that a field of view of each of said cameras overlaps with a field of view of at least one other one of said cameras of said group of cameras such that all fields of view are at least indirectly connected, said group of cameras having:
at least a first and a second camera with objective lenses which are disposed at a distance x of at least two meters from one another and/or with optical axes being oriented at an angle a of at least 45° with respect to one another;
said first camera is a thermal imaging camera for recording thermal radiation via continuous digital storage of 2D thermal images using at least one thermal imaging recorder;
said second camera is:
a further thermal imaging camera; or
a video image camera for recording light radiation via continuous digital storage of 2D video images using at least one video image recorder;
a calibration unit for ensuring spatial 3D calibration of all of said cameras with overlapping fields of view;
a synchronization unit for ensuring a recording of the 2D thermal images and any said 2D video images and is effected at a same time and/or recording time points of the 2D images are known;
a segmentation unit for segmenting associated 2D pixel regions of the object in synchronously available thermal images and any said video images according to predefined homogeneity criteria;
a reconstruction unit for reconstructing a 3D voxel model of the object from segmented 2D pixel regions;
a projection unit projecting the 3D voxel model as reference for a search space back into the synchronously available 2D thermal images and any said 2D video images; and
an identification unit for identifying silhouettes of the object in the synchronously available 2D thermal images and any said 2D video images on a basis of the search space that is defined by back projection.

17. The motion analysis system according to claim 16,
wherein an image frequency of the 2D video images recorded using said video image camera is greater than an image frequency of the 2D thermal images recorded using said thermal imaging camera; and
further comprising a 2D supplementation unit that supplements missing 2D thermal images in a manner such that a synchronous 2D thermal image is always present for each 2D video image.

18. The motion analysis system according to claim 16,
wherein a model frequency of 3D voxel models produced by said reconstruction unit is lower than an image frequency of the 2D thermal images recorded using said thermal imaging camera and/or any said 2D video images recorded using said video image camera; and
further comprising a 3D supplementation unit, which supplements missing said 3D voxel models in a manner such that for each said 2D thermal image and/or any said 2D video image a synchronous 3D voxel model is always present.

19. The motion analysis system according to claim 16, wherein:
said group of cameras has said thermal imaging camera and at least two video image cameras;
said first camera is said thermal imaging camera and said second camera is said video image camera, said objective lenses of said first and second cameras are disposed at a distance x of at least two meters from one another and/or the optical axes of which are oriented at the angle a of at least 45° with respect to one another; and
said group of cameras includes a third camera being a video image camera, an objective lens of said third camera is disposed immediately adjacent to said objective lens of said thermal imaging camera such that the optical axes of said first and third cameras are oriented substantially parallel with respect to one another.

20. The motion analysis system according to claim 16, wherein said segmentation unit, which is cycled through in an iterative sequence and in a process additionally takes into consideration the search space limitations from a preceding iteration step and adapts homogeneity criteria to a current iteration step.

21. The motion analysis system according to claim 16, wherein said reconstruction unit, which selects, in an iterative sequence, additionally the segmented 2D pixel regions used for reconstruction of the 3D voxel model in dependence on a current iteration step, a type of camera and/or a quality criteria of the 2D pixel regions.

22. The motion analysis system according to claim 16, wherein:
said group of cameras includes at least two thermal imaging cameras; and
said reconstruction unit, which initially reconstructs a 3D WB voxel model of the objects only from segmented 2D WB pixel regions.

23. The motion analysis system according to claim 22, wherein said projection unit, which initially projects back the 3D WB voxel model as a reference for the search space into the synchronously available 2D thermal images and any said 2D video images.

24. The motion analysis system according to claim 16, further comprising an assignment unit, which assigns points of previously known silhouettes of a model of the object as a correspondence to points of identified silhouettes and/or assigns the points of the identified silhouettes as correspondence to the points of the previously known silhouettes of the model of the object.

25. The motion analysis system according to claim 16, further comprising an assignment unit, which additionally to correspondences obtained from data of the silhouettes, uses data of further sensors, any image processing units and/or a depth image camera for establishing correspondences.

26. The motion analysis system according to claim 24, further comprising a weighting unit, which weights established correspondences in accordance with fixedly predefined and/or variable parameters.

27. The motion analysis system according to claim 16, further comprising a motion analysis unit, which analyzes poses and/or movements of the object from a finally available orientation of a model of the object.

28. A motion analysis and tracking system, comprising:
a motion analysis system according to claim 16; and
a motion tracking unit, which performs a reorientation of a model of the object from assigned correspondences.

29. The motion analysis and tracking system according to claim 28, wherein said motion tracking unit, which, in an iterative procedure, carries out after each iteration, with already present correspondences and/or with correspondences which have been re-established, a reorientation of the model of the object until an orientation of the model meets a predefined criterion.

30. The motion analysis and tracking system according to claim 28, further comprises a motion analysis unit, which analyzes poses and/or movements of the object from a finally available orientation of the model of the object.

31. The motion analysis and tracking system according to claim 30, further comprising a visualization unit, which uses texture mapping to visualize temperature data of segmented 2D WB pixel regions on the 3D voxel model and/or on an aligned model.
